(19) United States
(12) Patent Application Publication
(10) Pub. No.: US 2023/0170501 A1
(43) Pub. Date: Jun. 1, 2023

(54) WATER DRAIN SYSTEM FOR A FUEL CELL VEHICLE AND A CONTROL METHOD THEREFOR

(71) Applicants: HYUNDAI MOTOR COMPANY, Seoul (KR); KIA CORPORATION, Seoul (JP)

(72) Inventor: Keun Bong Ham, Yongin-si (KR)

(73) Assignees: HYUNDAI MOTOR COMPANY, Seoul (KR); KIA CORPORATION, Seoul (KR)

(21) Appl. No.: 17/876,185

(22) Filed: Jul. 28, 2022

(30) Foreign Application Priority Data
Nov. 26, 2021 (KR) 10-2021-0165864

(51) Int. Cl. H01M 8/04119; H01M 8/04223; H01M 8/04701

(52) U.S. Cl. CPC H01M 8/04156; H01M 8/04253; H01M 8/04701; H01M 2250/20

(57) ABSTRACT

A water drain system for a fuel cell vehicle and a control method therefor that derives an expected location where the water drain system for the fuel cell vehicle is expected to be operated. Further, the water drain system for a fuel cell vehicle and the control method therefor operates the water drain system in advance before the vehicle reaches the expected location to discharge the generated water of the fuel cell, so that the freezing at a specific location, such as a parking lot, due to excessive concentration of discharged water, is prevented, and the marketability of the fuel cell vehicle is further improved.

### CROSS-REFERENCE TO RELATED APPLICATION

The present application claims priority to Korean Patent Application No. 10-2021-0165864, filed Nov. 26, 2021, the entire contents of which are incorporated herein for all purposes by this reference.

### BACKGROUND

### Field of the Disclosure

The present disclosure relates to a water drain system for a fuel cell vehicle and a control method therefor. More particularly, a water drain system for a fuel cell vehicle and a control method therefor which derives an expected location where the water drain system for the fuel cell vehicle is expected to be operated. Further, the water drain system for a fuel cell vehicle and the control method therefor operates the water drain system in advance before the vehicle reaches the expected location to discharge the generated water of the fuel cell. In this way, freezing of the discharged water at a specific location, such as a parking lot, due to excessive concentration of discharged water is prevented. In addition, the marketability of the fuel cell vehicle is further improved.

### Description of the Related Art

A fuel cell receives hydrogen as a fuel and oxygen from the air. The fuel cell generates electrical energy through an electrochemistry reaction between hydrogen and oxygen. Such a fuel cell is applied to a fuel cell vehicle, and the like. The vehicle is driven by operating an electric motor with the electric energy produced through the fuel cell.

When the fuel cell vehicle is driven, hydrogen and oxygen react in the fuel cell to generate water. The generated water reduces the active surface area of a catalyst layer and causes a loss in electrode reaction. In addition, the water (generated water) increases a mass transfer resistance causing a voltage drop, thereby deteriorating the performance of the fuel cell.

Accordingly, the fuel cell vehicle needs to frequently discharge the generated water while the fuel cell vehicle is driving in order to prevent a flooding phenomenon. The flooding phenomenon occurs when the generated water is excessively accumulated.

Recently, fuel cell vehicles have been equipped with a function to forcibly drain water. The function to forcibly drain water is performed when a user presses a water drain button at a desired location.

On the other hand, in general, when the air temperature is low, such as during winter, when the engine of the fuel cell vehicle is stopped, a phenomenon in which the generated water remaining in the fuel cell is frozen frequently occurs. When the inside of the fuel cell is frozen, the hydrogen/oxygen flow path or diffusion layer is blocked, making it difficult to smoothly supply the hydrogen/oxygen for the operation of the fuel cell. This makes it difficult for a normal electrochemistry reaction to occur, which reduces the performance of the fuel cell. Further, there is a problem in that the engine does not start properly even when the fuel cell vehicle is restarted after a predetermined period of time has elapsed from the state in which the operation of the fuel cell vehicle is stopped (next startability).

Thus, currently, a user of a fuel cell vehicle equipped with the function to forcibly drain water generally presses the water drain button in a parking lot during winter. Accordingly, the surface of the parking lot may become frozen during the winter, which may cause the number of residential grievances and petitions to increase.

In addition, the conventional water drain button is operated only by the user's manipulation. Therefore, an inconvenience is created in that the user has to press the water drain button every time he or she enters the parking lot at a time when freezing is expected.

The matters described as the background technology of the present disclosure are only for improving the understanding of the background of the present disclosure. The matters should not be taken as acknowledging that they correspond to the prior art already known to those having ordinary skill in the art.

### SUMMARY

The present disclosure has been proposed to solve the above-mentioned problem. The object of the present disclosure is to provide a water drain system for a fuel cell vehicle and a control method therefor, which derives an expected location where the water drain system of a fuel cell is expected to be operated. The water drain system for a fuel cell vehicle and the control method therefor operates the water drain system in advance (i.e., before the vehicle reaches the expected location) to discharge the generated water of the fuel cell. This is achieved to prevent freezing at a specific location, such as a parking lot, due to the excessive concentration of discharged water. Furthermore, the marketability of the fuel cell vehicle is further improved.

In order to achieve the above object, a method for controlling a water drain system for a fuel cell vehicle includes the steps of deriving an expected location where a water drain system of a fuel cell is expected to be operated. The method also includes discharging generated water of the fuel cell by operating the water drain system in advance before a vehicle reaches the expected location.

In the step of deriving the expected location, any one of a location where the water of the fuel cell is discharged, a location where an operation of the fuel cell is stopped, a location where the vehicle is parked, a user's designated location, and a navigation destination, may be derived as the expected location.

In the step of deriving the expected location, the expected location may be updated while the vehicle is driving.

In the step of discharging the generated water of the fuel cell, the generated water of the fuel cell may be discharged when a current location of the vehicle is within a set distance of the expected location.

In the step of discharging the generated water of the fuel cell, a time for the vehicle to reach the expected location from a set distance of the expected distance is set as a set time, and the generated water of the fuel cell may be discharged before the set time is reached.

In the step of discharging the generated water of the fuel cell, the generated water of the fuel cell may be discharged only when a current location of the vehicle is located on a driving path.

In the step of discharging the generated water of the fuel cell, the generated water of the fuel cell may be discharged only when an outside air temperature of the vehicle satisfies a preset temperature condition.

In the step of discharging the generated water of the fuel cell of a method for controlling a water drain system of a fuel cell vehicle, according to the present disclosure, the outside air temperature of the vehicle may be an outside air temperature at the expected location.

A water drain system for a fuel cell vehicle, according to the present disclosure, may include a water drain unit that selectively discharges generated water of a fuel cell, a location derivation unit that derives an expected location where a water drain system of a fuel cell is expected to be operated, and a control unit. The control unit controls the water drain system so that the generated water of the fuel cell is discharged in advance before a vehicle reaches the expected location derived from the location derivation unit.

The water drain system for a fuel cell vehicle, according to the present disclosure, may further include a display unit that displays whether the water drain system of the fuel cell is in operation.

According to the water drain system for a fuel cell vehicle and a control method therefor of the present disclosure, an expected location where the water drain system for the fuel cell vehicle is expected to be operated is derived. Further, the water drain system is operated in advance before the vehicle reaches the expected location to discharge the generated water of the fuel cell, so that the freezing at a specific location, such as a parking lot, due to excessive concentration of discharged water, may be prevented. Furthermore, the marketability of the fuel cell vehicle may be further improved.

### BRIEF DESCRIPTION OF THE DRAWINGS

FIG. 1 is a flowchart of a method for controlling a water drain system for a fuel cell vehicle according to an embodiment of the present disclosure.

FIG. 2 is a view illustrating the discharge of generated water of a fuel cell based on an expected location in a method for controlling a water drain system for a fuel cell vehicle according to an embodiment of the present disclosure.

FIG. 3 is a view illustrating the discharge of generated water of a fuel cell based on a current location of a vehicle in a method for controlling a water drain system for a fuel cell vehicle according to an embodiment of the present disclosure.

FIG. 4 is a view illustrating the discharge of generated water of a fuel cell based on an outside air temperature of a vehicle in a method for controlling a water drain system for a fuel cell vehicle according to an embodiment of the present disclosure.

FIG. 5 is a view illustrating a water drain system for a fuel cell vehicle according to an embodiment of the present disclosure.

### DETAILED DESCRIPTION

Throughout this specification, when a part “includes” a certain component, it means that other components may be further included, rather than excluding other components, unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, the configuration and operating principle of various embodiments of the disclosed inventive concept are described in detail with reference to the accompanying drawings.

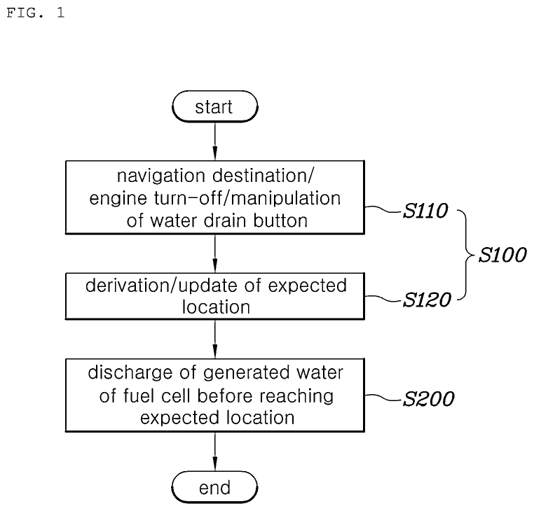

FIG. 1 is a flowchart of a method for controlling a water drain system for a fuel cell vehicle according to an embodiment of the present disclosure.

Referring to FIG. 1, the method for controlling a water drain system for a fuel cell vehicle, according to the present disclosure, includes the step of deriving an expected location where the water drain system of a fuel cell is expected to be operated (S100). In addition, the method for controlling the water drain system for a fuel cell vehicle further includes the step of discharging the generated water of the fuel cell by operating the water drain system in advance before the vehicle reaches the expected location (S200).

When the fuel cell vehicle is driven, hydrogen and oxygen react to generate water inside the fuel cell. Since the generated water deteriorates the performance of the fuel cell, it is desired for the fuel cell vehicle to frequently discharge the generated water while driving.

Furthermore, in a period when the atmospheric temperature is low, such as during winter, when the engine of the fuel cell vehicle is stopped without properly removing the generated water inside the fuel cell in advance, the phenomenon that the generated water remaining inside the fuel cell freezes frequently occurs.

In other words, when the fuel cell system is exposed/soaked at a temperature below the freezing point for a long time (e.g., Cold Soaking), the generated water remaining in each component of the system (e.g., inside the fuel cell stack or valves, and the like) is frozen. A problem occurs where the performance of the fuel cell and the next startability of the vehicle have deteriorated.

Recently, when the fuel cell vehicle equipped with the water drain forced function is applied, and when a user presses the water drain button at a desired location, the water drain is forcibly performed. Currently, the user of the fuel cell vehicle equipped with the water drain forced function presses the water drain button in a parking lot, and the like, generally before stopping the engine of the fuel cell vehicle. Accordingly, the surface of the parking lot may become frozen in the winter, which may cause the number of residential grievances and petitions to increase.

In addition, the conventional water drain button is operated only by the user's manipulation. There is an inconvenience in that the user has to press the water drain button every time he or she enters the parking lot at a time when freezing is expected.

Therefore, in the method for controlling the water drain for a fuel cell vehicle according to the present disclosure, an area (e.g., house, office, and the like) where the engine is frequently stopped is derived in advance as the expected location (S100). Further, the water drain system is operated in advance to discharge the generated water of the fuel cell before the vehicle reaches the expected location (S200). This is to prevent problems such as freezing of the parking lot surface, which has occurred in the conventional fuel cell vehicle equipped with the water drain forced function.

In addition, it is possible to solve the inconvenience of the user of the conventional vehicle by automatically operating the water drain system based on a predetermined distance or a predetermined time from the expected location without the user frequently operating the water drain button.

Hereinafter, the configuration and working principle of each step of the disclosed inventive concept is described in more detail with reference to the accompanying drawings.

FIG. 1 is a flowchart of a method for controlling a water drain system for a fuel cell vehicle according to an embodiment of the present disclosure.

Referring to FIG. 1, in step (S100) of deriving the expected location of the method for controlling a water drain system for a fuel cell vehicle, according to the present disclosure, any one of a location where the water of the fuel cell is discharged, a location where an operation of the fuel cell is stopped, a location where the vehicle is parked, a user's designated location, and a navigation destination, may be derived as the expected location (S110).

In FIG. 1, the navigation destination, the location where the engine is stopped, and the location where the water drain button is operated are described as expected locations for the purpose of understanding the disclosure. The scope of the present disclosure is not limited by the description of this drawing.

The location for discharging the water of the fuel cell may include a location where the operation of the fuel cell is stopped or the location designated by the user. The location where the operation of the fuel cell is stopped includes a location where the operation of the fuel cell is temporarily stopped (e.g., when visiting a gas station to fuel the fuel cell vehicle) or a location where the operation of the fuel cell is stopped for a long time, such as a vehicle parking lot. In addition, the user's designated location may include a navigation destination or a location where the user manually manipulates the water drain button.

When the vehicle parking lot or gas station is derived as the expected location, the water drain is performed in advance before the user drives the fuel cell vehicle to the parking lot or gas station, thereby preventing the concentration of discharged water by the user in the corresponding area. Accordingly, it is possible to reduce the number of civil petitions and safety problems caused by the freezing of the surface of the parking lot or gas station.

In the method for controlling a water drain system for a fuel cell vehicle, according to the present disclosure, it should be clearly understood that not only the expected location presented in the present specification, but also the matters not described are included as a configuration of the present disclosure if they meet the problem to be solved by the present disclosure.

In step (S100) of deriving the expected location of the method for controlling a water drain system of a fuel cell vehicle, according to the present disclosure, the expected location may be updated while the vehicle is driving (S120).

In this example, the update of the expected location may be understood as learning the case where the same location information on the expected location is repeated a certain number of times or more, and storing the learned information in the memory of the water drain system.

In other words, the location where the search information of the vehicle navigation is accumulated due to frequent visits by the user, the location where the user often turns off the engine (e.g., a parking lot at home or office), or the specific location where the user repeatedly manipulates the water drain system, is learned and the water drain system is automatically operated before reaching such expected location.

Therefore, since the user's usage pattern is learned to forcibly discharge the water, there is an effect of accumulating the user's experience and increasing the convenience.

For reference, when operating the water drain system, according to the learned location information, the convenience of the user of the fuel cell vehicle may be further improved by having the user select whether to operate the water drain system or not. In addition, the convenience of the user of the fuel cell vehicle may be further improved by displaying information that the water drain system is in operation before actual operation.

This may be implemented through a display unit, such as a display of a vehicle navigation or a built-in speaker of the vehicle, which are described below in detail.

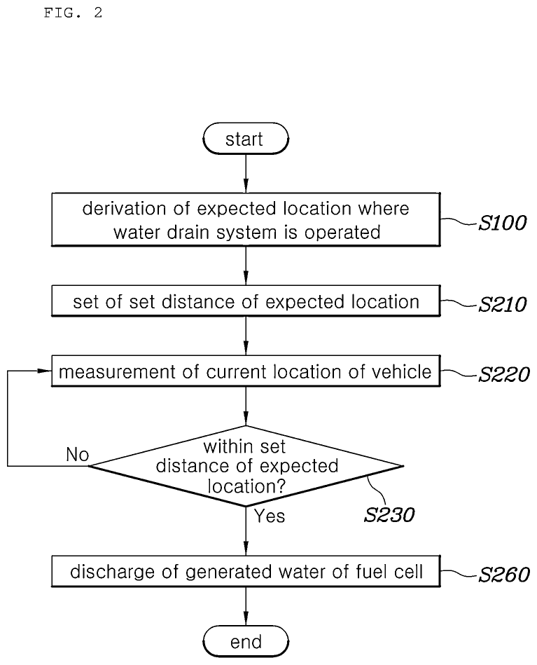

FIG. 2 is a view illustrating the discharge of generated water of a fuel cell based on an expected location in a method for controlling a water drain system for a fuel cell vehicle, according to an embodiment of the present disclosure.

Referring to FIG. 2, in step (S200) of discharging the generated water of the fuel cell in the method for controlling a water drain system for a fuel cell vehicle, according to the present disclosure, the generated water of the fuel cell may be discharged when the current location of the vehicle is within a set distance of the expected location.

For example, a certain radius range from the derived expected location may be set as the set distance of the expected location. In other words, when the vehicle arrives within a predetermined radius from the expected location, the water drain system of the fuel cell vehicle may be operated to discharge the generated water of the fuel cell.

Looking at this in more detail, first the set distance of the expected location is set from the derived expected location (S210). Second, the current location of the vehicle is measured (S220). By comparing the set distance of the expected location with the current location of the vehicle, if the current location of the vehicle has not yet reached the set distance, the current location of the vehicle is remeasured. If the current location of the vehicle reaches within the set distance (S230), the water drain system of the fuel cell vehicle may finally be operated (S260).

On the other hand, in step (S200) of discharging the generated water of the fuel cell in the method for controlling a water drain system of a fuel cell vehicle, according to the present disclosure, the time for the vehicle to reach the expected location from the set distance of the expected location is set as a set time. Thus, it is possible to discharge the generated water of the fuel cell before the set time.

As described above, when a predetermined radius range from the derived expected location is set as the set distance of the expected location, it is possible to derive the time needed for the vehicle to reach the expected location. The derived time for the vehicle to reach the expected location may be based on the distance information from the set distance of the expected location to the expected location and the driving speed information of the vehicle.

For reference, as described above, by using the vehicle's driving speed information as well as receiving the traffic condition information on the road from the set distance of the expected location to the expected location by using the vehicle navigation, it is apparent that the time for the vehicle to reach the expected location may be derived more specifically.

Where the set time is used in this way, even if the vehicle reaches within the set distance of the expected location, the water drain system of the fuel cell vehicle may not be immediately operated. However, according to specific conditions, the water drain system may be flexibly operated within the set time.

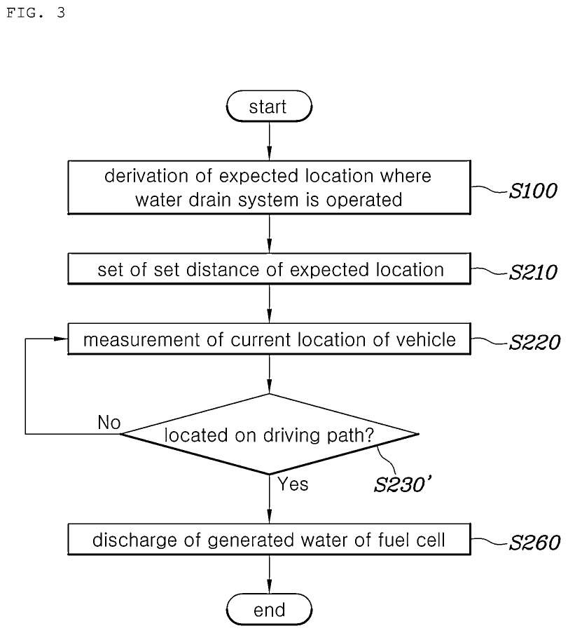

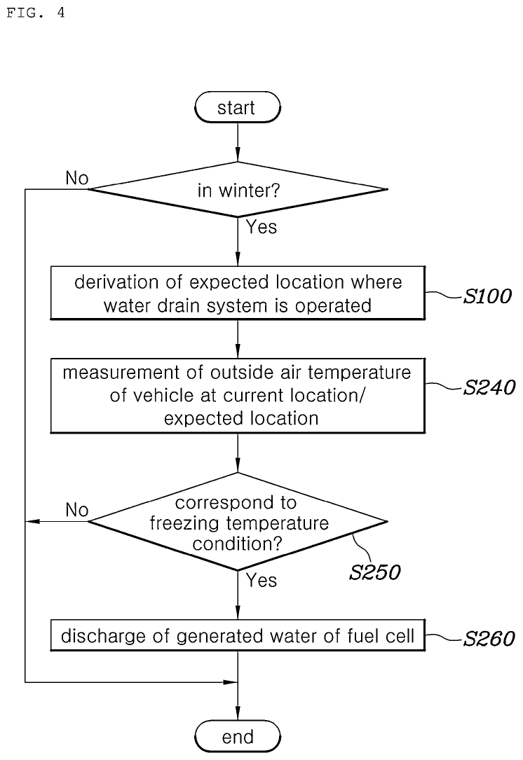

The specific condition may be understood to mean, for example, a case where the vehicle is located on a driving path, such as a road. The specific condition may also be understood to mean, for example, an outside air temperature condition of the vehicle. Hereinafter, these specific conditions are described in detail with reference to FIGS. 3 and 4.

FIG. 3 is a view illustrating the discharge of generated water of a fuel cell based on a current location of a vehicle in a method for controlling a water drain system for a fuel cell vehicle according to an embodiment of the present disclosure.

Referring to FIG. 3, in step (S200) of discharging the generated water of the fuel cell in the method for controlling a water drain system for a fuel cell vehicle, according to the present disclosure the generated water of the fuel cell may be discharged only when the current location of the vehicle is located on a driving path.

Even if water is discharged from the vehicle in advance, before reaching the expected location, the area where the vehicle discharges the water may correspond to a residential area or the entrance to a parking lot according to the set distance of the expected location.

When water is discharged in a residential area or at the entrance to a parking lot, the surface (i.e., floor) in that area may become frozen (e.g., covered in ice). The residents' grievances, petitions or safety problems due to the freezing of the surface at the expected location may create issues, which is what is to be solved by the present disclosure.

Therefore, the set distance of the expected location needs to be set to an area where the concentration of discharged water is not expected or a problem such as surface freezing is less likely to occur even if discharged water is performed, unlike the expected location described above.

In general, the concentration of discharged water is not expected on the driving path of a vehicle such as a road. In particular, during winter, sand or calcium chloride (CaCl²) is frequently sprayed on the driving path to prevent vehicles from slipping (e.g., sliding) due to the freezing of the surface of the driving path. Therefore, surface freezing may be prevented to some extent.

For reference, in order to discharge water, according to the above conditions, a multimedia device such as an AVN (Audio, Video, Navigation) of the vehicle may interwork with the water drain system of the vehicle.

Looking at this in more detail, first, the set distance of the expected location is set from the derived expected location (S210). Second, the current location of the vehicle is measured (S220). Comparing the current location of the vehicle with the road information on the current location received through the AVN, if the current location of the vehicle is not located on the driving path, the current location of the vehicle is remeasured. If the current location of the vehicle is located on the driving path (S230′), the water drain system of the fuel cell vehicle is finally operated (S260).

FIG. 4 is a view illustrating the discharge of generated water of a fuel cell based on an outside air temperature of a vehicle in a method for controlling a water drain system for a fuel cell vehicle, according to an embodiment of the present disclosure.

Referring to FIG. 4, in step (S200) of discharging the generated water of the fuel cell of the method for controlling a water drain system for a fuel cell vehicle, according to the present disclosure, the generated water of the fuel cell may be discharged only when the outside air temperature of the vehicle satisfies a preset temperature condition.

When the atmosphere temperature is low, such as during winter, in order to prevent the generated water remaining inside the fuel cell from freezing, it is desired to remove the generated water generated in the fuel cell in advance and then turn off the engine of the fuel cell vehicle, as described above.

In other words, the user of a fuel cell vehicle often manually manipulates the water drain forced function before stopping the engine of the vehicle in a parking lot and the like during winter. Accordingly, there is a serious problem in that the water discharged from a number of fuel cell vehicles may accumulate on the surface of the parking lot and the discharged water may freeze. This problem especially frequently occurs during cold weather, such as winter.

Accordingly, the present disclosure measures the outside air temperature of the vehicle at the current location of the vehicle so that the water drain system may be operated only when the freezing temperature condition of the generated water (e.g., 0° C. or less) is satisfied. It is apparent that the outside air temperature of the vehicle may be understood to mean the atmosphere temperature in the corresponding area.

Referring back to FIG. 4, the outside air temperature of the vehicle in step (S200) of discharging the generated water of the fuel cell of the method for controlling a water drain system for a fuel cell vehicle, according to the present disclosure, may be the outside air temperature at the expected location.

Even if the outside air temperature of the vehicle at the current location of the vehicle does not correspond to the freezing temperature condition, the outside air temperature at the expected location may correspond to the freezing temperature condition according to the destination of the vehicle. For example, if the destination of the vehicle corresponds to an alpine area or a mountainous area, since the atmosphere temperature is lower than the current location of the vehicle, the outside air temperature at the expected location may correspond to the freezing temperature condition.

Therefore, it is desired to determine whether to operate the water drain system by measuring not only the outside air temperature of the vehicle at the current location of the vehicle, but also the outside air temperature of the vehicle at the expected location where the vehicle engine is expected to be turned off.

Looking at this in more detail, when the driving time of the vehicle does not correspond to a cold weather period, such as winter, the control may be terminated without operating the water drain system. When the driving time of the vehicle corresponds to winter, the expected location of the vehicle is derived (S100). Further, the outside air temperatures at the current location of the vehicle from the derived expected location and at the expected location are measured (S240). It is also determined whether the outside air temperature of the vehicle corresponds to the freezing temperature condition of the generated water. If the outside air temperature of the vehicle does not correspond to the freezing temperature condition, the control may be terminated without operating the water drain system. Further, if the outside air temperature of the vehicle is the freezing temperature (S250), the water drain system of the fuel cell vehicle may be finally operated (S260).

Accordingly, it is possible to improve the marketability of the fuel cell vehicle by resolving the surface freezing problem that occurs particularly frequently during the winter.

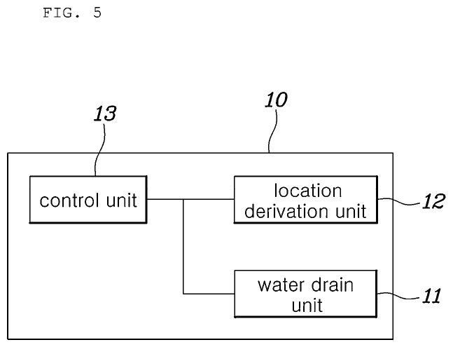

FIG. 5 is a view illustrating a water drain system for a fuel cell vehicle according to an embodiment of the present disclosure.

Referring to FIG. 5, the water drain system 10 for a fuel cell vehicle, according to the present disclosure, includes a water drain unit 11 that selectively discharges the generated water of the fuel cell, a location derivation unit 12 that derives the expected location where the water drain system of the fuel cell is expected to be operated, and a control unit 13. The control unit 13 controls the water drain system so that the generated water of the fuel cell is discharged in advance before the vehicle reaches the expected location derived from the location derivation unit 12.

The control unit 13, according to an embodiment of the present disclosure, may be implemented through a non-volatile memory (not shown) configured to store an algorithm configured to control the operation of various components of a vehicle or the data relating to software instructions for reproducing the algorithm. Further, a processor (not shown) is configured to perform operations described below using the data stored in the corresponding memory. The memory and the processor may be implemented as separate chips. Alternatively, the memory and processor may be implemented as a single chip integrated with each other, and the processor may take the form of one or more processors.

The water drain unit 11 is an operating unit that discharges the water of the fuel cell vehicle. The water drain unit 11 may selectively discharge the generated water generated inside the fuel cell according to a control condition of the control unit 13. In other words, the water drain unit 11 may additionally include a communication unit (not shown) that receives information from the control unit 13 and a hydrogen/air compressor (not shown) or a pressure transducer (not shown) for discharging water.

The location derivation unit 12 may be interlocked with a multimedia device (not shown) such as an AVN to derive the expected location, the set distance of the expected location, and the set time, or to measure the current location of the vehicle. In addition, a temperature sensor (not shown) that detects the outside air temperature of the vehicle at the current location of the vehicle or at the expected location may be further provided.

The control unit 13 may control the location derivation unit 12 to derive the expected location, the set distance of the expected location, and the set time, or to measure the current location of the vehicle. The control unit 13 may also control the water drain unit 11 to discharge the water only when a specific condition (e.g., the case where the vehicle is located on the driving path or the case where the outside air temperature of the vehicle corresponds to the freezing temperature condition of the generated water) is satisfied.

The water drain system for a fuel cell vehicle, according to the present disclosure, may further include a display unit (not shown). The display unit may display whether the water drain system of the fuel cell is in operation.

A display of the navigation mounted on the vehicle or a built-in speaker of the vehicle may be used as the display unit. The display unit may allow the user to select whether to finally operate the water drain system, or display information that the water drain system is in operation, before operating the water drain system.

In other words, the user may decide whether to operate the water drain system finally by himself or herself. Further, it is possible to check whether the fuel cell system is operating normally, so that the convenience of the user of the fuel cell vehicle is further improved.

Furthermore, the information provided to the user by the display unit may prevent the corresponding information from being displayed according to the user's desires. In addition, when the vehicle's built-in speaker is used as the display unit, the above information may be delivered to the user through voice.

Although the present disclosure has been shown and described with reference to specific embodiments, it should be apparent to those having ordinary skill in the art that the present disclosure may be variously improved and changed without departing from the spirit of the present disclosure provided by the following claims.

What is claimed is:

1. A method for controlling a water drain system for a fuel cell vehicle, the method comprising the steps of:
deriving an expected location where the water drain system of a fuel cell is expected to be operated; and
discharging generated water of the fuel cell by operating the water drain system in advance before the fuel cell vehicle reaches the expected location.

2. The method according to claim 1, wherein in the step of deriving the expected location, any one of a location where the water of the fuel cell is discharged, a location where an operation of the fuel cell is stopped, a location where the fuel cell vehicle is parked, a user's designated location, and a navigation destination, is derived as the expected location.

3. The method according to claim 1, wherein in the step of deriving the expected location, the expected location is updated while the fuel cell vehicle is driving.

4. The method according to claim 1, wherein in the step of discharging the generated water of the fuel cell, the generated water of the fuel cell is discharged when a current location of the fuel cell vehicle is within a set distance of the expected location.

5. The method according to claim 1, wherein in the step of discharging the generated water of the fuel cell, a time for the fuel cell vehicle to reach the expected location from a set distance of an expected distance is set as a set time, and the generated water of the fuel cell is discharged before the set time.

6. The method according to claim 1, wherein in the step of discharging the generated water of the fuel cell, the generated water of the fuel cell is discharged only when a current location of the fuel cell vehicle is located on a driving path.

7. The method according to claim 1, wherein in the step of discharging the generated water of the fuel cell, the generated water of the fuel cell is discharged only when an outside air temperature of the fuel cell vehicle satisfies a preset temperature condition.

8. The method according to claim 7, wherein the outside air temperature of the fuel cell vehicle is an outside air temperature at the expected location.

9. A water drain system for a fuel cell vehicle, the water drain system comprising:
a water drain unit that selectively discharges generated water of a fuel cell;
a location derivation unit that derives an expected location where a water drain system of a fuel cell is expected to be operated; and
a control unit that controls the water drain system so that the generated water of the fuel cell is discharged in advance before the fuel cell vehicle reaches the expected location derived from the location derivation unit.

10. The water drain system according to claim 9, further comprising a display unit that displays whether the water drain system of the fuel cell is in operation.
